(19) United States
(12) Patent Application Publication
(10) Pub. No.: US 2017/0277712 A1
(43) Pub. Date: Sep. 28, 2017

(54) INFORMATION PROCESSING METHOD AND ELECTRONIC DEVICE

(71) Applicant: Lenovo (Beijing) Limited, Beijing (CN)

(72) Inventors: Lieyong Chen, Beijing (CN); Liqiang Liu, Beijing (CN)

(21) Appl. No.: 15/472,255

(22) Filed: Mar. 28, 2017

(30) Foreign Application Priority Data
Mar. 28, 2016 (CN) 201610183687.6

(51) Int. Cl. G06F 17/30; H04L 29/08

(52) U.S. Cl. CPC G06F 17/30179; H04L 67/06; H04L 67/02; H04L 67/36

(57) ABSTRACT

One embodiment provides a method, including: obtaining partial information content from a first file, wherein the partial information content is recorded in the first file and comprises an indication of a selection of at least a portion of the first file; generating a second file different from the first file based on the partial information content; and sharing the second file with at least one electronic device. Other aspects are described and claimed.

### CLAIM FOR PRIORITY

This application claims priority to Chinese Application No. 201610183687.6 which was filed on Mar. 28, 2016, and which is fully incorporated by reference herein.

### TECHNICAL FIELD

The present subject matter described therein relates to the field of electronic technologies, and in particular, to an information processing method and an electronic device.

### BACKGROUND

With the development of science and technology, various intelligent devices have emerged and have largely driven the rapid development of information. In daily life, people are in contact with a lot of information, and more and more people like to share their interests with other users by way of intelligent devices, such as text, pictures, and web pages.

In the process of information sharing, currently, electronic devices can only share the whole file or the whole web page containing the contents of a portion the user's interest with other users.

### BRIEF SUMMARY

In summary, one aspect provides a method, comprising: obtaining partial information content from a first file, wherein the partial information content is recorded in the first file and comprises an indication of a selection of at least a portion of the first file; generating a second file different from the first file based on the partial information content; and sharing the second file with at least one electronic device.

Another aspect provides an electronic device, comprising: a housing; a processor; and a memory device that stored instructions executable by the processor to: obtain partial information content from a first file, wherein the partial information content is recorded in the first file and comprises an indication of a selection of at least a portion of the first file; generate a second file different from the first file based on the partial information content; and share the second file with at least one electronic device.

A further aspect provides a product, comprising: a storage device having code stored therewith, the code being executable by the processor and comprising: code that determines, at an electronic device, partial information content from a first file, wherein the partial information content is recorded in the first file; code that generate, at an electronic device, a second file different from the first file based on the partial information content; and code that shares, at an electronic device, the second file with at least one electronic device.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the embodiments will be pointed out in the appended claims.

### BRIEF DESCRIPTION OF THE SEVERAL VIEWS OF THE DRAWINGS

To describe the technical solutions in the embodiments of the present application more clearly, hereinafter, drawings that are used for description of the embodiments are briefly described. It is apparent that the drawings described hereinafter merely illustrate some embodiments of the matter described therein.

FIG. 1 is a schematic flow diagram of an information processing method in an embodiment.

FIG. 2A shows the information contents included in a first file before an electronic device shares the partial information content in an information processing method in an embodiment.

FIG. 2B shows the information contents included in a second file after the electronic device processes the partial information content in an information processing method in an embodiment.

FIG. 3 is a schematic flow diagram for a method of step S101 in an information processing method in an embodiment.

FIG. 4 is a schematic flow diagram for one method of step S102 in an information processing method in an embodiment.

FIG. 5 is a schematic flow diagram for the other method of step S102 in an information processing method in an embodiment.

FIG. 6 is a schematic flow diagram for a method of step S103 in an information processing method in an embodiment.

FIG. 7 is a schematic diagram of an electronic device provided in an embodiment.

FIG. 8 is a schematic diagram of an electronic device provided in an embodiment.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

An embodiment provides an information processing method and an electronic device for solving the technical problem that the electronic devices in the prior art have a low sharing accuracy and thereby achieving the technical effect of higher sharing accuracy.

In order to solve the foregoing technical problem, the general ideas of the technical solution in the embodiments of the present application are as follows: determining partial information content from a first file, wherein the partial information content is recorded in the first file; generating the second file different from the first file based on the partial information content; and sharing the second file with at least one other electronic device.

In the technical solution in the embodiments of the present application, partial information content is determined from a first file, wherein the partial information content is recorded in the first file; a second file different from the first file is generated based on the partial information content; and the second file is shared with at least one other electronic device. That is, different information content in the same file can be specifically shared with other electronic devices, thereby ensuring accurate sharing in electronic devices and achieving a higher sharing accuracy.

In order to better understand the foregoing technical solution, the technical solution of the matter described therein is described in detail below through accompanying drawings and specific embodiments. It should be understood that embodiments of the application and specific features in the embodiments are used for describing the technical solution in detail, and are not intended to limit the technical solution of the present embodiments. The embodiments of the application and the technical features in the embodiments may be combined with each other without conflict.

In the embodiments provided based on the technical solution of the present application, the electronic device may specifically be a smart phone, a notebook computer, a tablet PC, a desktop computer or the like, therefore they are not listed one by one herein.

### Embodiment 1

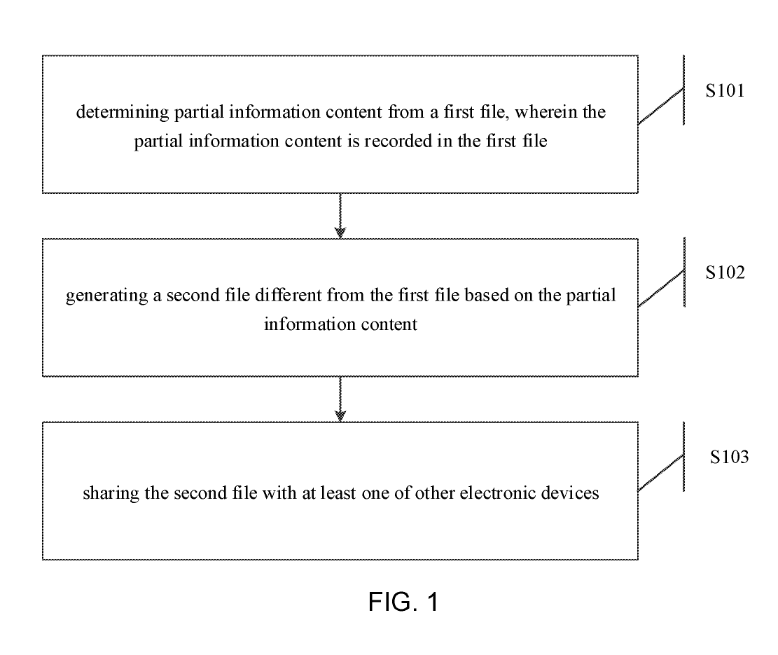

Referring to FIG. 1, Embodiment 1 of the present application provides an information processing method, including: S101: determine partial information content from a first file, wherein the partial information content is recorded in the first file; S102: generate a second file different from the first file based on the partial information content; S103: share the second file with at least one other electronic device.

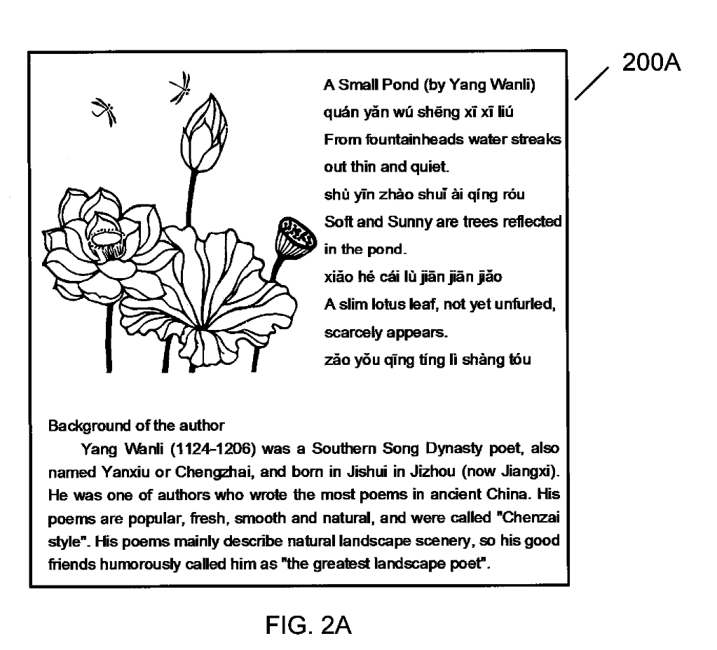

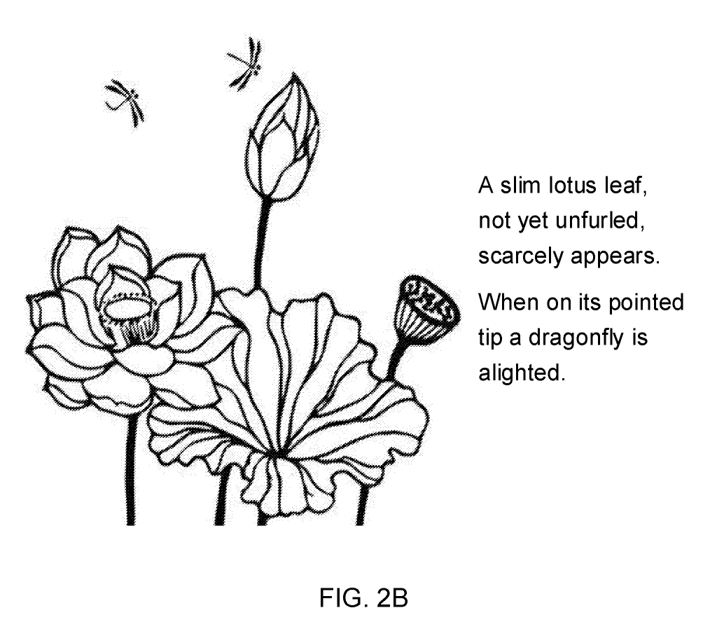

In specific implementation processes, the specific implementation processes of step S101 to step S103 are as follows: First, partial information content is determined from a first file, wherein the partial information content is recorded in the first file. For example, the first file is specifically a word file which includes information content such as text, pictures, tables, and hyperlinks. For example, a user determines partial text content from the word file, and partial pictures constituting the partial information content. Then, a second file different from the first file is generated based on the partial information content. For a specific example, what is shown in FIG. 2A is all the information content included in the first file. When the determined partial information content has text content corresponding to ‘a slim lotus leaf, not yet unfurled, scarcely appears; when on its pointed tip a dragonfly is alighted’ and a picture corresponding to ‘a dragonfly alights on a budding lotus’, on the basis of these information content, a file consisting of the aforementioned text content and picture, is obtained, as is shown in FIG. 2B. Afterwards, the second file is shared with at least one other electronic device. For example, the file is shared with a mobile phone B through a mobile phone A. For another example, the file is shared with a mobile phone C through a tablet PC and the like, therefore they are not listed one by one herein.

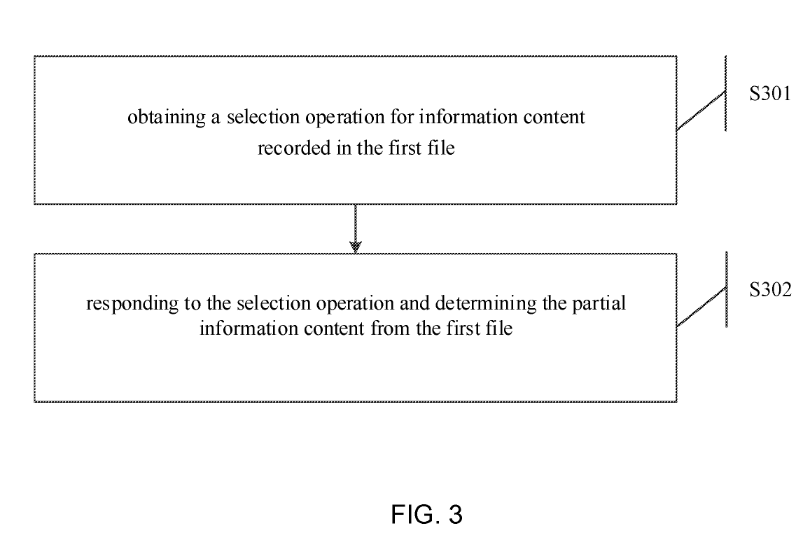

The discussion now turns to an embodiment is shown in FIG. 3. Step 101, determine partial information content from a first file specifically includes: S301: obtain a selection operation for information content recorded in the first file; S302: respond to the selection operation and determine the partial information content from the first file.

The specific implementation processes of step S301 to step S302 are as follows: first, a selection operation for information contents recorded in the first file is obtained; for example, the selection operation may specifically be an operation of specifically selecting partial words from the first file through an input device; for another example, it may be an operation of directly checking the picture; for another example, it may be an operation of acquiring a screen shot containing information content to be selected through an input device, etc.; a person skilled in the art can use specific selection operations according to specific requirements of the user, which are not thoroughly listed herein. Then, the partial information content is determined from the first file in response to the selection operation.

In addition, in an embodiment, besides selecting the information content determined to be shared from the same file, the information content to be shared can also be selected from multiple different files according to the requirements of the user; for example, selecting picture a and text t from file A, selecting picture b from file B, and finally sharing an information content consisting of picture a, text t, and picture b to other electronic devices. The implementation principles are similar to those described above, therefore they are not explained in detail herein.

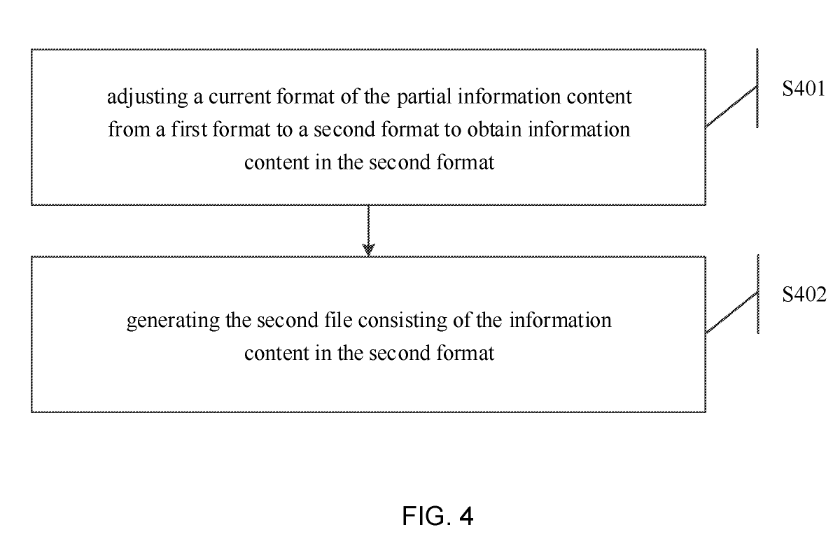

An embodiment is shown in FIG. 4. Step 102, generate a second file different from the first file based on the partial information content specifically includes: S401: adjust a current format of the partial information content from a first format to a second format to obtain information content in the second format; S402: generate the second file consisting of the information content in the second format.

The specific implementation processes of step S401 to step S402 are as follows: specifically, when multiple information content to be shared are obtained, in order to improve user experience, the current format of the partial information content is firstly adjusted from a first format to a second format to obtain information content in the second format. For example, before sharing, the partial information content includes text a in Song typeface size 3, text b in regular script size 4, and picture G with 5××5 length and width. In order to ensure that the content to be shared may bring better visual experience to the sharers, the format of the information content to be shared is properly adjusted to improve the user experience. Still using the example above, before the sharing, text a is adjusted from Song typeface size 3 to regular script size 4; according to the selecting order of each sub-information content in the partial information content, text a, text b, and picture G can be controlled to be arranged in a first order. For example, they can be arranged vertically or horizontally, and so on. Certainly, the current format of each information content in the partial information content can also be adjusted according to other standards such as the logic order in which the pictures and words appear. A person skilled in the art can certainly adjust the current format of the partial information content according to the actual use habits of the user, therefore it will not be described in detail herein.

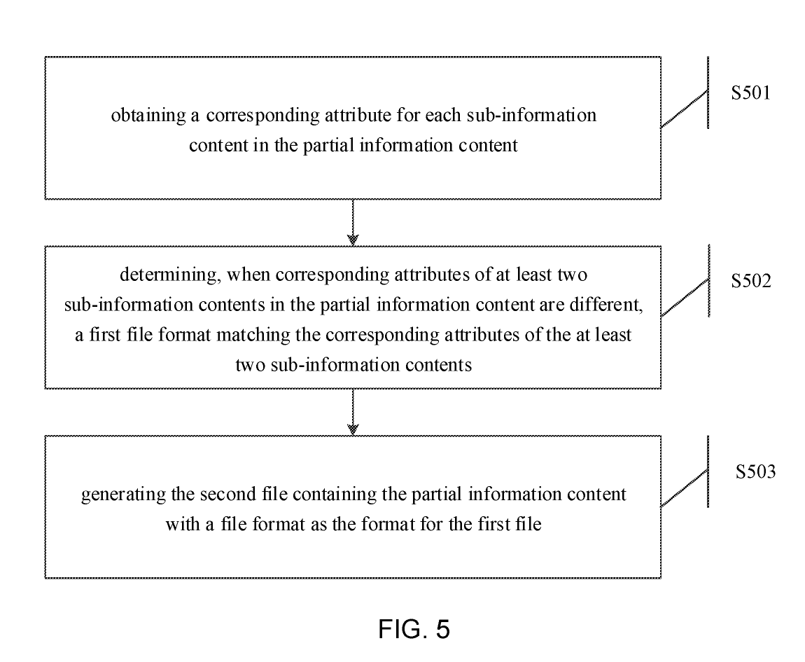

In an embodiment, before sharing, when at least two sub-information contents in the partial information content have different corresponding attributes, in order to further improve sharing quality and bring better sharing experience to the users, please now refer to Step 102 in FIG. 5, wherein Step 102, generate a second file different from the first file based on the partial information content specifically includes: S501: obtain a corresponding attribute for each sub-information content in the partial information content; S502: determine, when corresponding attributes of at least two sub-information contents in the partial information content are different, a first file format matching the corresponding attributes of the at least two sub-information contents; S503: generate the second file containing the partial information content with a file format as the format for the first file.

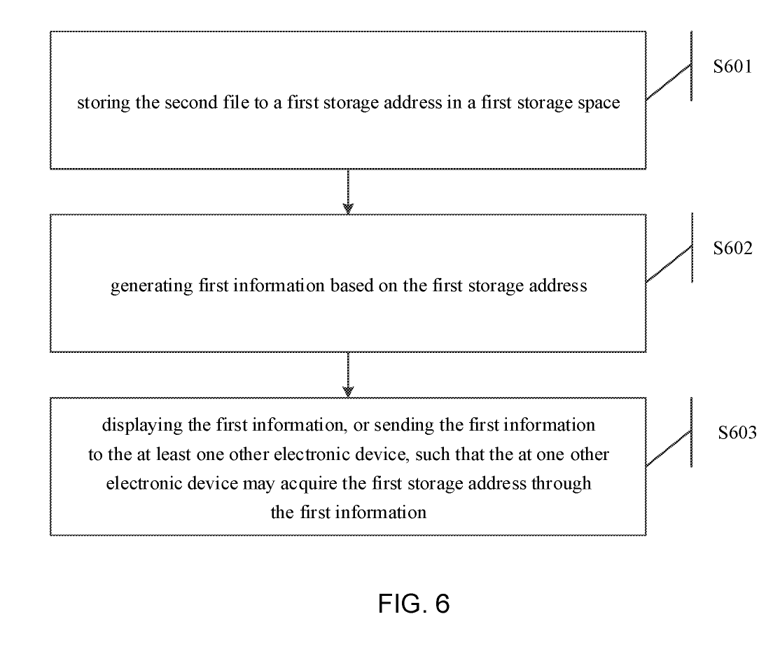

The specific implementation processes of step S501 to step S503 are as follows: first, a corresponding attribute of each sub-information content in the partial information content is obtained. Specifically, the attributes are specifically a “.Txt” text format, a “.Jpg” picture format, a “.Gif” picture format, an “.mp3” audio format, a “.Wav” audio format, and the like. When corresponding attributes of at least two sub-information contents in the partial information content are different, a first file format matching the corresponding attributes of the at least two sub-information contents is determined. For a specific example, when the corresponding attribute of each sub-information content in the partial information content is the “.Txt” text format, the “.Jpg” picture format, and the “.Gif” picture format, the current formats of the information content to be shared are uniformly adjusted to the “.Jpg” picture format before sharing. Certainly, according to the actual requirements of the user, it is also possible to adjust all the text contents to the “.Txt” text format, all the picture formats to the “.Jpg” picture format, and all the audio formats to the “.mp3” audio format, which are not listed in detail herein. Then, the second file containing the partial information content with the file format as the format of the first file is generated. Certainly, according to the actual use habits of users, a person skilled in the art can design to generate a second file different from the first file based on the partial information content, therefore it is not explained in detail herein. In an embodiment of the present application, please refer to FIG. 6, wherein Step 103, share the second file with at least one other electronic device specifically includes: S601: store the second file to a first storage address in a first storage space; S602: generate first information based on the first storage address; S603: display the first information, or send the first information to the at least one other electronic device, such that the at least one other electronic device may acquire the first storage address through the first information.

The specific implementation processes of step S601 to step S603 are as follows: First, the second file is stored to a first storage address in a first storage space. For example, the second file is stored to a designated directory of a local server or a cloud server corresponding to the electronic device, and a first storage address at which the second file is stored in the storage space is obtained. Moreover, the first information is generated based on the first storage address. Then, the first information is displayed. In an embodiment of the present application, the first information is specifically a two-dimensional code connection address corresponding to the first storage address, or an “external link” information corresponding to the first storage address. When the first information is specifically the two-dimensional code connection address corresponding to the first storage address, other electronic devices can acquire the first storage address through the first information by scanning the two-dimensional code connection address, to further obtain the second file. In addition, name, size, and summary besides the first information, or the name, size and summary of the first file may also be included, in order to facilitate the sharers easily understanding the contents in the second file according to the first information and deciding whether there is a need to acquire the specific contents in the second file through the first information. In such a way, the user can judge, according to the additional contents presented by the first information, whether there is a need to obtain the first file through the first information; and if not, the users of other electronic devices can select not to receive the contents to be shared, thereby further improving the quality of information sharing.

In the specific implementation process, after the first information is generated, the first information may also be directly sent to at least one other electronic device, for example, the first information is directly pushed to at least one other electronic device. Further, the at least one other electronic device can directly obtain the second file based on the first information. Certainly, in the specification implementation process, in order to ensure the information safety of the at least one other electronic device, the user corresponding to the at least one other electronic device can also manually select whether to view the second file shared by said electronic device. Certainly, a person skilled in the art can also design solutions of sharing the second file with the at least one other electronic device by said electronic device according to actual requirements of the user, therefore they are not listed one by one herein.

### Embodiment 2

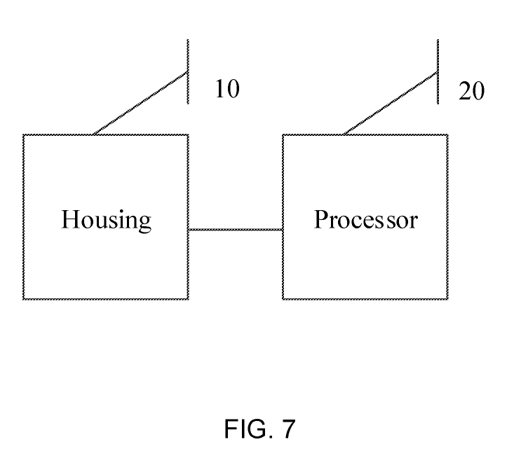

An embodiment is shown in FIG. 7 that provides an electronic device, including: a housing 10; and a processor 20 connected to the housing 10, wherein the processor 20 is configured to: determine partial information content from a first file, wherein the partial information content is recorded in the first file; generate a second file different from the first file based on the partial information content; and share the second file with at least one electronic device.

In an embodiment, the processor 20 is configured to: obtain a selection operation for information content recorded in the first file; and respond to the selection operation and the partial information content from the first file.

In an embodiment, the processor 20 is also configured to: adjust a current format of the partial information content from a first format to a second format to obtain information content in the second format; and generate the second file consisting of the information content in the second format.

In an embodiment, the processor 20 is further configured to: obtain a corresponding attribute for each sub-information content in the partial information content; determine, when corresponding attributes of at least two sub-information contents in the partial information content are different, a first file format matching the corresponding attributes of the at least two sub-information contents; and generate the second file containing the partial information content with a file format as the format of the first file.

In an embodiment, the processor 20 is further configured to: store the second file to a first storage address in a first storage space; generate first information based on the first storage address; and display the first information, or send the first information to the at least one other electronic device, such that the at least one other electronic device acquires the first storage address through the first information.

### Embodiment 3

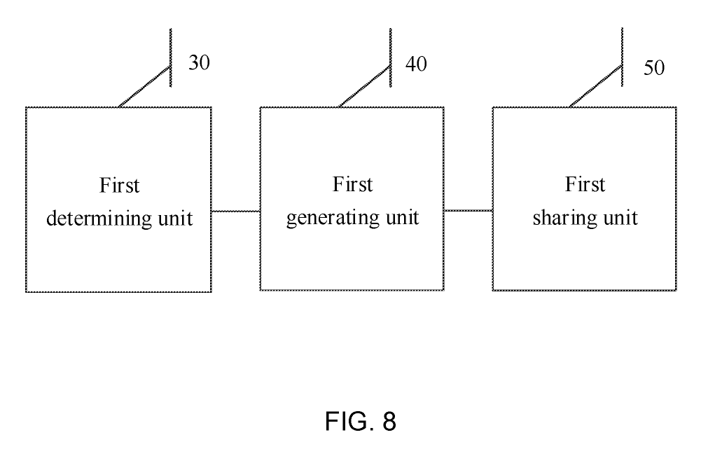

Referring now to FIG. 8, an embodiment provides an electronic device, including: a first determining unit 30, used for determining (obtaining) partial information content from a first file, wherein the partial information content is recorded in the first file; a first generating unit 40, used for generating a second file different from the first file based on the partial information content; and a first sharing unit 50, used for sharing the second file with at least one other electronic device.

In an embodiment, the first determining unit 30 specifically includes: a first obtaining module, used for obtaining a selection operation for information content recorded in the first file; and a first determining module, used for responding to the selection operation and determining the partial information content from the first file.

In an embodiment, the first generating unit 40 specifically includes: a second obtaining module, used for adjusting a current format of the partial information content from a first format to a second format to obtain information content in the second format; and a first generating module, used for generating the second file consisting of the information content in the second format.

In an embodiment, the first generating unit 40 specifically includes: a third obtaining module, used for obtaining a corresponding attribute for each sub-information content in the partial information content; a second determining module, used for determining, when corresponding attributes of at least two sub-information contents in the partial information content are different, a first file format matching the corresponding attributes of the at least two sub-information contents; and a second generating module, used for generating the second file containing the partial information content with a file format as the format of the first file.

In an embodiment, the first sharing unit 50 specifically includes: a first storage module, used for storing the second file to a first storage address in a first storage space; a third generating module, used for generating first information based on the first storage address; and a first processing module, used for displaying the first information, or sending the first information to the at least one other electronic device, such that the at least one other electronic device acquires the first storage address through the first information.

By means of one or more technical solutions in the embodiments, the following one or more technical effects can be achieved:

In the technical solution in the embodiments, partial information content are determined from a first file, wherein the partial information content are recorded in the first file; a second file different from the first file is generated based on the partial information content; and the second file is shared with at least one other electronic device. That is, the partial information content acquired in the same file can be pointedly shared with other electronic devices, thereby ensuring accurate sharing of the electronic device and achieving a higher sharing accuracy.

In the technical solution in an embodiment, the current format of the partial information content is adjusted from a first format into a second format to obtain information contents in the second format; and the second file consisting of the information contents in the second format is generated. That is, when the partial information content are shared, the current format of the partial information content can be adjusted, thereby bringing about a better user experience to the user.

In the technical solution in an embodiment, a corresponding attribute of each sub-information content in the partial information content is obtained; when corresponding attributes of at least two sub-information contents in the partial information content are different, therefore a first file format that matches the corresponding attributes of the at least two sub-information contents is determined; and the second file which contains the partial information content and the file format of which is the first file format is generated. That is, when the partial information content are shared, according to the current attributes of at least two sub-information contents in the partial information content, a first file format corresponding to the current attributes can be determined, and the partial information content are shared with other electronic devices in the first file format. A better service performance of the electronic device is ensured, and meanwhile, the user experience is improved.

Those skilled in the art should understand that the embodiments may be embodied as a method, a system or a computer program product. Therefore, the embodiments may be in the form of a hardware-only embodiment, a software-only embodiment, or an embodiment of a combination of hardware and software. Moreover, the embodiment may be in the form of a computer program product which is implemented on one or more computer usable storage media (including, but not limited to, disk storage, CD-ROM, optical storage, and the like) which contains computer usable program codes thereon.

The present embodiment is described with reference to the methods, devices (systems) and flow diagrams and/or block diagrams of computer program products according to the embodiments. It should be understood that computer program instructions may be used to implement each process and/or block in the flow diagrams and/or block diagrams, and combinations of processes and/or blocks in the flow diagrams and/or block diagrams. These computer program instructions may be provided to a general computer, a dedicated computer, an embedded processor or other programmable data processing devices to generate a machine, such that the instructions, which are executed via the processor of the computer or other programmable data processing devices, create means for implementing the functions specified in one or more flows of the flow diagram and/or one or more blocks of the block diagram.

These computer program instructions may also be stored in a computer readable memory that can direct a computer or other programmable data processing devices to function in a particular manner, such that the instructions stored in the computer readable memory produce an article of manufacture including instruction means implementing the function specified in one or more flows of the flow diagram and/or one or more blocks of the block diagram.

These computer program instructions may also be loaded onto a computer or other programmable data processing devices to make a series of operational steps to be performed on the computer or other programmable devices to produce a computer implemented process such that the instructions that are executed on the computer or other programmable devices provide steps for implementing the functions specified in one or more flows of the flow diagram and/or one or more blocks of the block diagram.

Specifically, the computer program instructions corresponding to the information processing method in an embodiment of the present application can be stored in a storage medium such as an optical disc, a hard disk, and a USB flash disk. When the computer program instructions corresponding to the information processing method in the storage medium are read or executed by an electronic device, the following steps are included: determining partial information content from a first file, wherein the partial information content is recorded in the first file; generating a second file different from the first file based on the partial information content; and sharing the second file with at least one other electronic device.

Optionally, the AND step stored in the storage medium, i.e., the obtaining partial information content from a first file, specifically includes the following steps when a corresponding computer instruction is performed: obtaining a selection operation for information content recorded in the first file; and responding to the selection operation and determining the partial information content from the first file.

Optionally, the AND step stored in the storage medium, i.e., generating, based on the partial information content, a second file different from the first file, specifically includes the following steps when a corresponding computer instruction is performed: adjusting a current format of the partial information content from a first format to a second format to obtain information content in the second format; and generating the second file consisting of the information content in the second format.

Optionally, the AND step stored in the storage medium, i.e., generating, based on the partial information content, a second file different from the first file, specifically includes the following steps when a corresponding computer instruction is performed: obtaining a corresponding attribute for each sub-information content in the partial information content; determining, when corresponding attributes of at least two sub-information contents in the partial information content are different, a first file format matching the corresponding attributes of the at least two sub-information contents; and generating the second file containing the partial information content with a the file format as the format of the first file.

Optionally, the AND step stored in the storage medium, i.e., sharing the second file with at least one other electronic device, specifically includes the following steps when a corresponding computer instruction is performed: storing the second file to a first storage address in a first storage space; generating first information based on the first storage address; and displaying the first information, or sending the first information to the at least one other electronic device, such that the at least one electronic device acquires the first storage address through the first information.

While preferred embodiments have been described, variations and modifications may be made to these embodiments once the basic inventive concept is obtained by those skilled in the art. Thus, the attached claims are intended to be explained as including the preferred embodiments and all variations and modifications that fall within the scope of the matter described therein.

Clearly, various variations and modifications to the embodiments may be made by those skilled in the art without departing from the spirit and scope of the present embodiments. Accordingly, if these variations and modifications to the embodiments fall within the scope of the claims of the embodiments and the equivalents thereof, it is also intended that the present matter described therein encompass these variations and modifications.

As will be appreciated by one skilled in the art, various aspects may be embodied as a system, method or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. A storage device may be, for example, a system, apparatus, or device (e.g., an electronic, magnetic, optical, electromagnetic, infrared, or semiconductor system, apparatus, or device) or any suitable combination of the foregoing. More specific examples of a storage device/medium include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage device is not a signal and “non-transitory” includes all media except signal media.

Program code embodied on a storage medium may be transmitted using any appropriate medium, including but not limited to wireless, wireline, optical fiber cable, RF, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices and program products according to various example embodiments. It will be understood that the actions and functionality may be implemented at least in part by program instructions. These program instructions may be provided to a processor of a device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

1. An method, comprising:
obtaining partial information content from a first file, wherein the partial information content is recorded in the first file and comprises an indication of a selection of at least a portion of the first file;
generating a second file different from the first file based on the partial information content; and
sharing the second file with at least one electronic device.

2. The method according to claim 1, wherein the obtaining partial information content from a first file comprises:
obtaining a selection operation for information content recorded in the first file; and
responding to the selection operation and determining the partial information content from the first file.

3. The method according to claim 1, wherein the generating a second file different from the first file based on the partial information content comprises:
adjusting a current format of the partial information content from a first format to a second format;
obtaining information content in the second format; and
generating the second file consisting of the information content in the second format.

4. The method according to claim 1, wherein the generating of a second file different from the first file based on the partial information content comprises:
obtaining a corresponding attribute for each sub-information content in the partial information content;
determining, when corresponding attributes of at least two sub-information contents in the partial information content differ, a first file format matching the corresponding attributes of the at least two sub-information contents; and
generating the second file containing the partial information content with a file format as the format for the first file.

5. The method according to claim 1, wherein the sharing the second file with at least one electronic device comprises:
storing the second file to a first storage address in a first storage space;
generating first information based on the first storage address; and
displaying the first information.

6. The method according to claim 1, wherein the sharing the second file with at least one electronic device comprises:
storing the second file to a first storage address in a first storage space;
generating first information based on the first storage address; and
sending the first information to the at least one electronic device, such that the at least one electronic device acquires the first storage address through the first information.

7. The method according to claim 1, wherein the obtaining partial information content from a first file comprises an at least one determining module for determining when corresponding attributes of at least two sub-information contents in the partial information content differ.

8. The method according to claim 1, wherein the generating a second file different from the first file based on the partial information content comprises an at least one generating unit for generating the second file consisting of the information content in the second format.

9. The method according to claim 1, wherein the sharing the second file with at least one electronic device is based upon a user input.

10. The method according to claim 3, wherein the adjusting a current format of the partial information content from a first format to a second format is based upon a user input.

11. An electronic device, comprising:
a housing;
a processor; and
a memory device that stored instructions executable by the processor to:
obtain partial information content from a first file, wherein the partial information content is recorded in the first file and comprises an indication of a selection of at least a portion of the first file;
generate a second file different from the first file based on the partial information content; and
share the second file with at least one electronic device.

12. The electronic device according to claim 11, wherein the processor executes instructions to:
obtain a selection operation for information content recorded in the first file; and
respond to the selection operation and determine the partial information content from the first file.

13. The electronic device according to claim 11, wherein the processor executes instructions to:
adjust a current format of the partial information content from a first format to a second format to obtain information content in the second format; and
generate the second file consisting of the information content in the second format.

14. The electronic device according to claim 11, wherein the processor executes instructions to:
obtain a corresponding attribute for each sub-information content in the partial information content;
determine, when corresponding attributes of at least two sub-information contents in the partial information content are different, a first file format matching the corresponding attributes of the at least two sub-information contents; and
generate the second file containing the partial information content with a file format as the format for the first file.

15. The electronic device according to claim 11, wherein the processor executes instructions to:
store the second file to a first storage address in a first storage space;
generate first information based on the first storage address; and
display the first information.

16. The electronic device according to claim 11, wherein the processor executes instruction to share the second file with at least one electronic device further comprises:
store the second file to a first storage address in a first storage space;
generate first information based on the first storage address; and
send the first information to the at least one other electronic device, such that the at least one electronic device acquires the first storage address through the first information.

17. The electronic device according to claim 11, wherein the processor executes instructions to obtain partial information content from a first file comprises an at least one determining module for determining when corresponding attributes of at least two sub-information contents in the partial information content differ.

18. The method according to claim 11, wherein the processor executes instructions to generate a second file different from the first file based on the partial information content comprises an at least one generating unit for generating the second file consisting of the information content in the second format.

19. The electronic device according to claim 11, wherein the processor executes instructions to share the second file with at least one electronic device comprises a user input.

20. A product, comprising:
a storage device having code stored therewith, the code being executable by the processor and comprising:
code that determines, at an electronic device, partial information content from a first file, wherein the partial information content is recorded in the first file;
code that generate, at an electronic device, a second file different from the first file based on the partial information content; and
code that shares, at an electronic device, the second file with at least one electronic device.
